(19) United States
(12) Patent Application Publication
(10) Pub. No.: US 2021/0161325 A1
(43) Pub. Date: Jun. 3, 2021

(54) CAPSULE COFFEE MACHINE

(71) Applicant: GUANGDONG BARSETTO ELECTRIC INDUSTRIAL CO., LTD, Foshan (CN)

(72) Inventors: JianGang GUO, Foshan (CN); HuaFeng ZENG, Foshen (CN); ZhuYuan ZHOU, Foshan (CN)

(21) Appl. No.: 16/616,531

(22) PCT Filed: Dec. 13, 2017
(86) PCT No.: PCT/CN2017/115763

§ 371 Date: Nov. 25, 2019

(30) Foreign Application Priority Data
Jun. 19, 2017 (CN) 201720709192.2

(51) Int. Cl. A47J 31/10; A47J 31/46; A47J 31/06; A47J 31/36

(52) U.S. Cl. CPC A47J 31/106; A47J 31/3628; A47J 31/0668; A47J 31/461

(57) ABSTRACT

The present invention relates to the technical field of coffee machines, and particularly relates to a capsule coffee machine comprising a brewing assembly and a nozzle connected to the brewing assembly and used for guiding the coffee out; the inlet end of the nozzle is connected to an elastic pressurizing member used for increasing the pressure of the coffee entering the nozzle; the outlet end of the nozzle is connected to a foaming cavity used for foaming the coffee ejected into the foaming cavity through the nozzle; the nozzle is further provided with a liquid discharging passage.

### TECHNICAL FIELD OF THE INVENTION

The present invention relates to the technical field of coffee machines, and more particularly, to a capsule coffee machine.

### BACKGROUND OF THE INVENTION

A capsule coffee machine is a novel coffee machine that has been sold recently on the market. When brewing coffee, a coffee capsule needs to be fed into the capsule coffee machine, and a cup of tasty coffee appears. Compared with a semi-automatic coffee machine and a full-automatic coffee machine, the capsule coffee machine is simple and convenient to operate, the brewed coffee is tasty, and the taste is consistent. Therefore, the capsule coffee machine becomes popular among coffee lovers. However, after brewing coffee by using a capsule coffee machine, the residual coffee in the coffee machine can flow out from the outlet, resulting in a difficult cleaning and a poor use experience. To solve this technical problem, the Chinese patent CN106175452A discloses an anti-dripping coffee machine, wherein a discharging assembly is connected to the brewing cavity of the coffee machine. The discharging assembly comprises a pressure release connecting tube arranged on the shell, a pressure release tube penetrating through the piston in a sealing manner and a pressure release valve. One end of the pressure release tube is communicated with the brewing cavity, the other end of the pressure release tube is connected to one end of the pressure release connecting tube, and the other end of the pressure release connecting tube is communicated with a pressure release water path. The pressure release tube and the pressure release connecting tube are communicated to form a pressure release water passage. The pressure release valve is used for communicating or blocking the pressure release water path and the pressure release water passage. When the water pump stops working, the brewing cavity is in a closed state, and the residual liquid in the capsule is discharged from the water inlet surface of the capsule through the pressure release water path by utilizing the residual high pressure in the brewing cavity. Thus, the dripping problem caused by the residual liquid in the coffee machine can be effectively solved. However, as the discharging assembly needs additional design, the structure of the coffee machine is complex, increasing the design cost and making the market promotion difficult.

### SUMMARY OF THE INVENTION

The purpose of the present invention is to solve the shortcomings in the prior art by providing a capsule coffee machine. According to the present invention, the residual coffee can be effectively prevented from dripping and the foaming effect of the coffee can be improved. The structure of the present invention is simple, achieving a low cost and an easy market promotion.

To achieve the above purpose, the present invention adopts the following technical solution:

A capsule coffee machine of the present invention comprising a brewing assembly and a nozzle connected to the brewing assembly and used for guiding the coffee out; the inlet end of the nozzle is connected to an elastic pressurizing member, and the elastic pressurizing member is used for increasing the pressure of the coffee entering the nozzle; the outlet end of the nozzle is connected to a foaming cavity, and the foaming cavity is used for foaming the coffee ejected into the foaming cavity through the nozzle; the nozzle is further provided with a liquid discharging passage; when the water pump of the coffee machine is stopped, the coffee enters the liquid discharging passage from the nozzle, and when the water pump of the coffee machine is initiated, the coffee is ejected into the foaming cavity from the nozzle; the capsule coffee machine of the present invention can effectively prevent the residual coffee from dripping and has a simple structure, achieving a low cost and an easy market promotion.

In another aspect of the present invention, the elastic pressurizing member comprises a water outlet valve. When the water pump of the coffee machine stops working, the water outlet valve blocks the communicating passage between the brewing assembly and the nozzle, and when the water pump of the coffee machine starts working, the water outlet valve releases the communicating passage between the brewing assembly and the nozzle. Through adopting a water outlet valve as the elastic pressurizing member, the coffee in the brewing assembly can selectively enter the foaming cavity or the liquid discharging passage, effectively preventing the residual coffee from continuously dripping from the nozzle when the water pump of the coffee machine stops working.

In another aspect of the present invention, the water outlet valve comprises a valve element and a spring. The spring is used for propelling the valve element to block the communicating passage between the brewing assembly and the nozzle. Through the interaction between the spring and the valve element, the pressure of the coffee entering the nozzle can be increased, enabling the coffee to enter the nozzle as more as possible so that the residual coffee can be reduced.

In another aspect of the present invention, the liquid discharging passage is formed between the outlet end of the nozzle and the foaming cavity along the radial direction of the nozzle. When the water pump of the coffee machine ceases, the pressure of the residual coffee is comparatively low, enabling the residual coffee to be discharged from the liquid discharging passage instead of entering the nozzle.

In another aspect of the present invention, the elastic pressurizing member comprises an elastic pad. When the water pump of the coffee machine stops working, the elastic pad blocks the communicating passage between the brewing assembly and the nozzle, and when the water pump of the coffee machine starts working, the water outlet valve releases the communicating passage between the brewing assembly and the nozzle. Through adopting an elastic pad as the elastic pressurizing member, the coffee in the brewing assembly can selectively enter the foaming cavity or the liquid discharging passage, effectively preventing the residual coffee from continuously dripping from the nozzle when the water pump of the coffee machine stops working.

In another aspect of the present invention, the elastic pad comprises an installation portion and a deformation portion. The installation portion is used for installing and fixing the elastic pad, and the deformation portion is used for generating deformation under the pressure of the coffee, thereby blocking or releasing the communicating passage between the brewing assembly and the nozzle. Through the interaction between the installation portion and the deformation portion, the pressure of the coffee entering the nozzle can be increased, enabling the coffee to enter the nozzle as more as possible so that the residual coffee can be reduced.

In another aspect of the present invention, a communicating hole is formed in the deformation portion for communicating the brewing assembly and the nozzle when the water pump of the coffee machine works normally, thereby allowing the coffee to smoothly enter the elastic pad from the brewing assembly and then selectively enter the foaming cavity or the liquid discharging passage.

In another aspect of the present invention, a hole formed in the nozzle in the radial direction forms the liquid discharging passage. When the water pump of the coffee machine is stopped, the pressure of the residual coffee is comparatively low, enabling the residual coffee to be discharged from the liquid discharging passage instead of entering the nozzle.

Compared with the prior art, the present invention has the following advantages:

According to the capsule coffee machine of the present invention, the coffee discharged from the brewing assembly undergoes a second pressurization by means of the elastic pressurizing member arranged between the brewing assembly and the nozzle, thereby increasing the pressure of the coffee entering the nozzle. When the water pump of the coffee machine is stopped, the coffee enters the liquid discharging passage from the nozzle, and when the water pump of the coffee machine is initiated, the coffee is ejected into the foaming cavity from the nozzle. The coffee ejected into the foaming cavity can flow out from the outlet of the coffee machine and then enter the coffee cup. The residual coffee entering the liquid discharging passage can be collected by a residue tray of the coffee machine. As the residual coffee cannot stay in the coffee machine, the residual coffee can be effectively prevented from dripping continuously. Moreover, the foaming effect of the coffee can be improved, making the foam of the coffee thicker. Through adopting the novel anti-dripping structure of the present invention, the structure of the coffee machine can be simplified, achieving a low cost and an easy market promotion.

### BRIEF DESCRIPTION OF THE DRAWINGS

FIG. 1 is a structural diagram of the present invention;

FIG. 2 is a structural diagram of the first embodiment of the present invention;

FIG. 3 is a structural diagram illustrating the first state of the second embodiment of the present invention;

FIG. 4 is a structural diagram illustrating the second state of the second embodiment of the present invention.

In the Figures:

1-Brewing Assembly, 2-Nozzle, 3-Foaming Cavity, 4-Liquid Discharging Passage, 5-Valve Element, 6-Spring, 7-Installation Portion, 8-Deformation Portion, 9-Communicating Hole.

### DETAILED DESCRIPTION OF THE INVENTION

Drawings and detailed embodiments are combined hereinafter to elaborate the technical solutions of the present invention.

As shown in FIG. 1, the capsule coffee machine of the present invention comprises a brewing assembly 1 and a nozzle 2 connected to the brewing assembly 1 and used for guiding the coffee out. The inlet end of the nozzle 2 is connected to an elastic pressurizing member, and the elastic pressurizing member is used for increasing the pressure of the coffee entering the nozzle 2. The outlet end of the nozzle 2 is connected to a foaming cavity 3, and the foaming cavity 3 is used for foaming the coffee ejected into the foaming cavity 3 through the nozzle 2. The nozzle 2 is further provided with a liquid discharging passage 4. When the water pump of the coffee machine is stopped, the coffee enters the liquid discharging passage 4 from the nozzle 2, and when the water pump of the coffee machine is initiated, the coffee is ejected into the foaming cavity 3 from the nozzle 2. According to the capsule coffee machine of the present invention, the coffee discharged from the brewing assembly 1 undergoes a second pressurization by means of the elastic pressurizing member arranged between the brewing assembly 1 and the nozzle 2, thereby increasing the pressure of the coffee entering the nozzle 2. When the water pump of the coffee machine is stopped, the coffee enters the liquid discharging passage 4 from the nozzle 2, and when the water pump of the coffee machine is initiated, the coffee is ejected into the foaming cavity 3 from the nozzle 2. The coffee ejected into the foaming cavity 3 can flow out from the outlet of the coffee machine and then enter the coffee cup. The residual coffee entering the liquid discharging passage 4 can be collected by a residue tray of the coffee machine. As the residual coffee cannot stay in the coffee machine, the residual coffee can be effectively prevented from dripping continuously. Moreover, the foaming effect of the coffee can be improved, making the foam of the coffee thicker. The novel anti-dripping structure of the present invention makes the structure of the coffee machine become simpler, and achieves a low cost and an easy market promotion.

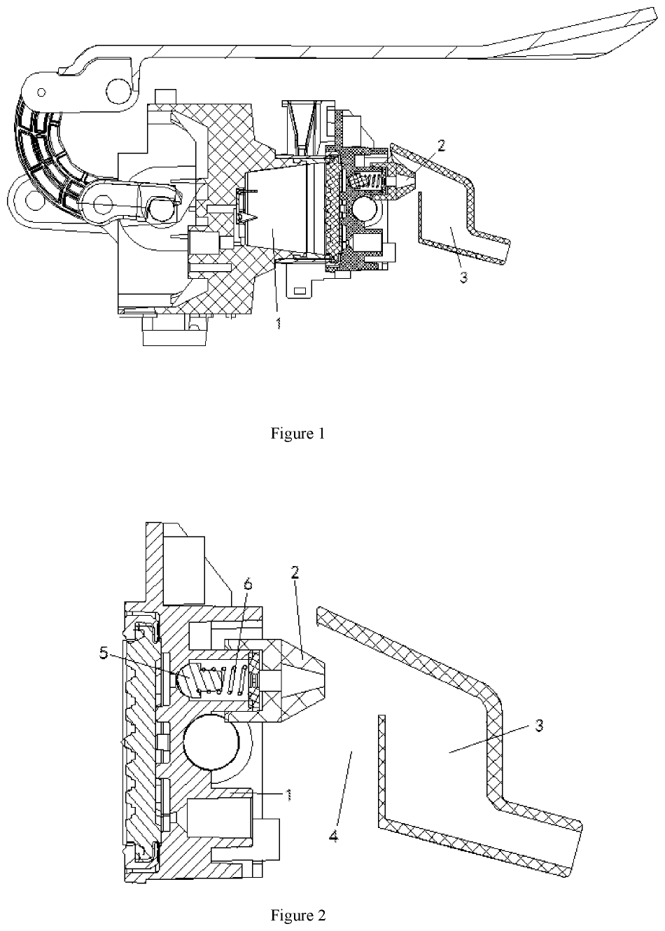

In the first embodiment of the present invention, as shown in FIG. 2, the elastic pressurizing member comprises a water outlet valve, and specifically, the water outlet valve comprises a valve element 5 and a spring 6. The spring 6 is used for propelling the valve element 5 to seal a communicating passage between the brewing assembly 1 and the nozzle 2, and the liquid discharging passage 4 is formed between the outlet end of the nozzle 2 and the foaming cavity 3 along the radial direction of the nozzle 2. When the water pump of the coffee machine stops working, the pressure of the coffee in the brewing assembly 1 is comparatively low, and the valve element 5 can seal the communicating passage between the brewing assembly 1 and the nozzle 2 under the action of the elastic force of the spring 6, thus avoiding the residual coffee in the brewing assembly 1 from entering the nozzle 2. At this point, the pressure of the residual coffee in the nozzle 2 is low, the ejection distance of the coffee ejected from the nozzle 2 is short. As the liquid discharging passage 4 is formed by the space between the foaming cavity 3 and the outlet end of the nozzle 2, and the ejection distance of the residual coffee in the nozzle 2 is not enough, the residual coffee cannot be ejected into the foaming cavity 3 but flow into the liquid discharging passage 4. When the water pump of the coffee machine works normally, the pressure of the coffee in the brewing assembly 1 is comparatively high. At this point, for the spring 6 propels the valve element 5 to keep sealing the communicating passage between the brewing assembly 1 and the nozzle 2, the coffee in the brewing assembly 1 is continuously pressurized. When the pressure of the coffee in the brewing assembly 1 can overcome the elastic force of the spring 6, the coffee presses the valve element 5, thus enabling the communicating passage between the brewing assembly 1 and the nozzle 2 to be opened. Thus, the coffee with high pressure flows into the inlet end of the nozzle 2 from the brewing assembly 1, and is ejected from the outlet end of the nozzle 2. As the pressure of the coffee is high and the ejection distance is long enough, the coffee ejected from the nozzle 2 directly passes through the liquid discharging passage 4 to enter the foaming cavity 3. Meanwhile, the coffee undergoes a second foaming in the foaming cavity 3 so that the foaming effect of coffee is greatly improved. According to the first embodiment of the present invention, the residual coffee can be effectively prevented from entering the nozzle 2 so that the dripping problem can be solved.

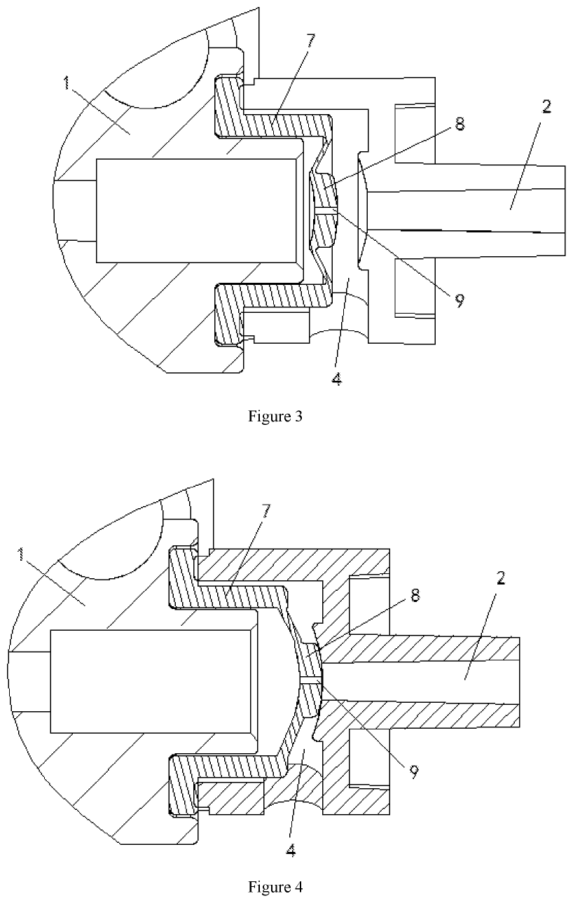

In the second embodiment of the present invention, as shown in FIGS. 3 and 4, the elastic pressurizing member comprises an elastic pad, and the elastic pad comprises an installation portion 7 and a deformation portion 8. The installation portion 7 is used for installing and fixing the elastic pad, and the deformation portion 8 is used for generating deformation under the pressure of the coffee, thereby blocking or releasing the communicating passage between the brewing assembly 1 and the nozzle 2. A communicating hole 9 is formed in the deformation portion 8 for communicating the brewing assembly 1 and the nozzle 2 when the water pump of the coffee machine works normally, and a hole formed in the nozzle 2 in the radial direction forms the liquid discharging passage 4. As shown in FIG. 3, in the first state of the second embodiment, when the water pump of the coffee machine is stopped, the pressure of the coffee in the brewing assembly 1 is comparatively low, and the coffee with low pressure cannot deform the deformation portion 8. As a result, the deformation portion 8 stays in the original position, and is kept a certain distance from the nozzle 2. At this point, the coffee with low pressure in the brewing assembly 1 flows out from the communicating hole in the deformation portion 8, enters the space between the deformation portion 8 and the nozzle 2, and flows out from the liquid discharging passage 4. In this way, the residual coffee can be prevented from entering the nozzle 2. As shown in FIG. 4, in the second state of the second embodiment, when the water pump of the coffee machine works normally, the pressure of the coffee in the brewing assembly 1 is comparatively high, and the deformation portion 8 possesses a certain elasticity, capable of blocking the coffee and further increasing the pressure of the coffee in the brewing assembly 1. When the pressure of the coffee in the brewing assembly 1 is high enough to deform the deformation portion 8, the deformation portion 8 deforms and moves towards the nozzle 2. Finally, the deformation portion 8 is attached to the inlet end of the nozzle 2, enabling the brewing assembly 1 and the liquid discharging passage 4 to be isolated by the deformation portion 8. At this point, the communicating hole 9 is communicated with the inlet end of the nozzle 2, allowing the coffee with high pressure in the brewing assembly 1 to pass through the inner cavity of the installation portion 7 and the communicating hole 9 of the deformation portion 8 to enter the nozzle 2. The coffee ejected from the outlet end of the nozzle 2 can also enter the foaming cavity 3, making the coffee undergo the second foaming in the foaming cavity 3. Thus, the foaming effect of the coffee can be improved. According to the second embodiment of the present invention, the dripping problem caused by the residual coffee entering the nozzle 2 can also be solved.

The above embodiments are merely the preferred embodiments of the present invention. Therefore, equivalent changes or modifications made according to the structures, features and principles described in the application range of the present invention shall be included within the protection scope of the present invention.

1. A capsule coffee machine, comprising:
a brewing assembly, and
a nozzle connected to the brewing assembly and used for guiding the coffee out, wherein the inlet end of the nozzle is connected to an elastic pressurizing member, and the elastic pressurizing member is used for increasing the pressure of the coffee entering the nozzle, wherein the outlet end of the nozzle is connected to a foaming cavity, and the foaming cavity is used for foaming the coffee ejected into the foaming cavity through the nozzle, wherein the nozzle is further provided with a liquid discharging passage, wherein when the water pump of the coffee machine is stopped, the coffee enters the liquid discharging passage from the nozzle, and when the water pump of the coffee machine is initiated, the coffee is ejected into the foaming cavity from the nozzle.

2. The capsule coffee machine of claim 1, wherein the elastic pressurizing member comprises a water outlet valve, wherein when the water pump of the coffee machine stops working, the water outlet valve blocks the communicating passage between the brewing assembly and the nozzle, and when the water pump of the coffee machine starts working, the water outlet valve releases the communicating passage between the brewing assembly and the nozzle.

3. The capsule coffee machine of claim 2, wherein the water outlet valve comprises a valve element and a spring, wherein the spring is used for propelling the valve element to block the communicating passage between the brewing assembly and the nozzle.

4. The capsule coffee machine of claim 2, wherein the liquid discharging passage is formed between the outlet end of the nozzle and the foaming cavity along the radial direction of the nozzle.

5. The capsule coffee machine of claim 1, wherein the elastic pressurizing member comprises an elastic pad, wherein when the water pump of the coffee machine stops working, the elastic pad blocks the communicating passage between the brewing assembly and the nozzle, and when the water pump of the coffee machine starts working, the water outlet valve releases the communicating passage between the brewing assembly and the nozzle.

6. The capsule coffee machine of claim 5, wherein the elastic pad comprises an installation portion and a deformation portion, wherein the installation portion is used for installing and fixing the elastic pad, and the deformation portion is used for generating deformation under the pressure of the coffee, thereby blocking or releasing the communicating passage between the brewing assembly and the nozzle.

7. The capsule coffee machine of claim 6, wherein a communicating hole is formed in the deformation portion for communicating the brewing assembly and the nozzle when the water pump of the coffee machine works normally.

8. The capsule coffee machine of claim 7, wherein a hole formed in the nozzle in the radial direction forms the liquid discharging passage.
